(19) United States
(12) Patent Application Publication
(10) Pub. No.: US 2021/0252611 A1
(43) Pub. Date: Aug. 19, 2021

(54) DEEP-HOLE DRILL AND DRILLING TOOL HAVING ONE OR MORE DEPRESSIONS IN THE CUTTING SURFACE

(71) Applicant: botek Präzisionsbohrtechnik GmbH, Riederich (DE)

(72) Inventor: Gotthold Schur, Neuffen (DE)

(73) Assignee: botek Präzisionsbohrtechnik GmbH, Riederich (DE)

(21) Appl. No.: 16/973,658

(22) PCT Filed: Mar. 21, 2019
(86) PCT No.: PCT/EP2019/057070

§ 371 Date: Dec. 9, 2020

(30) Foreign Application Priority Data
Jun. 13, 2018 (DE) 10 2018 114 139.4

(51) Int. Cl. B23B 51/00

(52) U.S. Cl. CPC B23B 51/00; B23B 2251/14; B23B 2251/248

(57) ABSTRACT

The invention relates to single-lip drills and double-lip drills, in which one or more depressions are formed in the rake face. The depressions according to the invention are arranged in the longitudinal direction of the tool at a distance from the cutting edge and have a positive influence on chip breaking.

The invention relates to a deep hole drill having one or more depressions in the rake face. The rake face of the drilling tools according to the invention is mostly planar and not, as is the case e.g. with a twist drill, coiled.

The terms essential for the disclosure of the invention are explained, inter alia, in conjunction with the description of the figures. Furthermore, at the end of the description of the figures, individual terms are explained in the form of a glossary.

A single-lip drill which has a chip-forming device that extends parallel to the outer cutting edge is known from DE 103 16 116 A1. Such a chip-forming device starts at the outer diameter of the drill and extends over most of the outer cutting edge.

This design of a chip-forming device is intended to lead to favorable formation of chips and thus allow faster machining. In the case of this drill, the cutting edge is formed by the chip-forming device and the flank. This means that the wedge angle of the cutting edge is smaller than that of a deep hole drill without a chip-forming device.

### Problem Addressed by the Invention

The problem addressed by the invention is that of providing a deep hole drill (single-lip drill or double-lip drill) or another drilling tool which is also suitable for machining tough and/or long-chipping materials. In addition, the deep hole drill is intended to have a longer service life than conventional drilling tools having chip-forming devices.

According to the invention, this problem is solved for a deep hole drill or another drilling tool comprising a drill head, in which the drill head has an axis of rotation, a drilling diameter and one or two cutting edges and in which a rake face is assigned to each cutting edge, by at least one depression being machined into the rake face.

A depression according to the invention is a recess machined into the rake face. A narrow strip of the rake face remains between one edge of the depression and the (main) cutting edge of the drilling tool. In other words: The depression is not part of the cutting edge. This is where a depression differs from a chip-forming device; the latter is directly adjacent to the (main) cutting edge or forms part of the cutting edge.

In many cases, a narrow strip of the rake face also remains between the secondary cutting edge of the drilling tool and the edge of a depression according to the invention.

Surprisingly, it has been found in drilling tests that the depressions, although they are at a certain distance from the cutting edge, have a positive effect on chip formation. In particular when machining tough materials, the chips become shorter due to the influence of the depression.

Because the depression is at a certain distance from the cutting edge, the cutting edge is not weakened by the depression, as is the case with conventional chip-forming devices. The service life of a deep hole drill according to the invention having a depression is therefore very long. In the dependent claims, dimensions for the distance between the depression and the main and the secondary cutting edge are claimed, which have proven to be suitable in drilling tests.

It is obvious that the invention is not limited to specific geometries of depressions.

A depression according to the invention can have the shape of an isosceles or non-isosceles triangle in a plane which extends orthogonally to the cutting edge. It can also have the shape of a circular segment or some other curved shape in cross section. It is also possible for the depressions to be composed of straight surfaces and/or surfaces which have been curved (once or multiple times).

In a further, advantageous embodiment of the invention, there is also a distance between one edge of the depressions and the secondary cutting edge; the secondary cutting edge is therefore not weakened by the depression either. This has a positive effect on the service life of the cutting corner, which results from the intersection of the outer cutting edge and the secondary cutting edge. This is particularly advantageous because the wear of a deep hole drill usually starts at the cutting corner. At the same time, the depressions positively influence chip formation; long-chipping materials can therefore be machined effectively, as well.

In a further, advantageous embodiment of the invention, two or more depressions according to the invention are present in the rake face of the deep hole drill. The depressions are usually arranged next to one another along the main cutting edge.

If only one depression is provided, said depression does not have to be positioned in the center of the main cutting edge. Rather, it is possible and often advantageous if the depression is arranged so as to be offset somewhat in the direction of the secondary cutting edge. Even with a relatively small depression, a significant positive effect on chip formation can be achieved.

The deep hole drill according to the invention can also be provided with a chip divider which divides the cutting edge into an inner portion and an outer portion. This reduces the width of the chips.

It has also proven to be advantageous if a depression is assigned to the inner portion of the cutting edge. Correspondingly, a depression can be assigned to the outer portion of the cutting edge. This results in further, very effective embodiments (a depression in the inner portion of the cutting edge, a depression in the outer portion of the cutting edge, and one depression each in the inner and outer portion of the cutting edge), in which a very positive effect on chip formation is achieved involving relatively little effort in order to introduce the depression(s) into the rake face.

In a further, advantageous embodiment of the invention, at least the drill head of the deep hole drill according to the invention is completely or partially provided with a wear protection layer, in particular a hard material coating, after the depression according to the invention has been introduced.

The advantages of the invention are also achieved by the method according to the invention.

Further details, features and advantages of the subject matter of the invention result from the dependent claims and from the following description of the associated drawings, in which a plurality of embodiments of the invention are shown by way of example.

It is obvious that the invention can be applied to the most varied of shapes and geometries of depressions. Therefore, the geometries of depressions shown in the figures do not limit the scope of protection of the claimed invention, but serve primarily for explanation and illustration.

### DRAWINGS

In the drawings:

FIGS. 1 and 2 show a single-lip drill (prior art);

FIG. 3 shows a view from the front of the single-lip drill according to FIG. 1;

FIG. 4 shows a double-lip drill according to the invention;

FIG. 5 shows a single-lip drill according to the invention having a depression;

FIG. 6 shows a single-lip drill according to the invention having a chip divider and depressions; and

FIG. 7 shows different shapes of depressions according to the invention.

### DESCRIPTION OF THE EMBODIMENTS

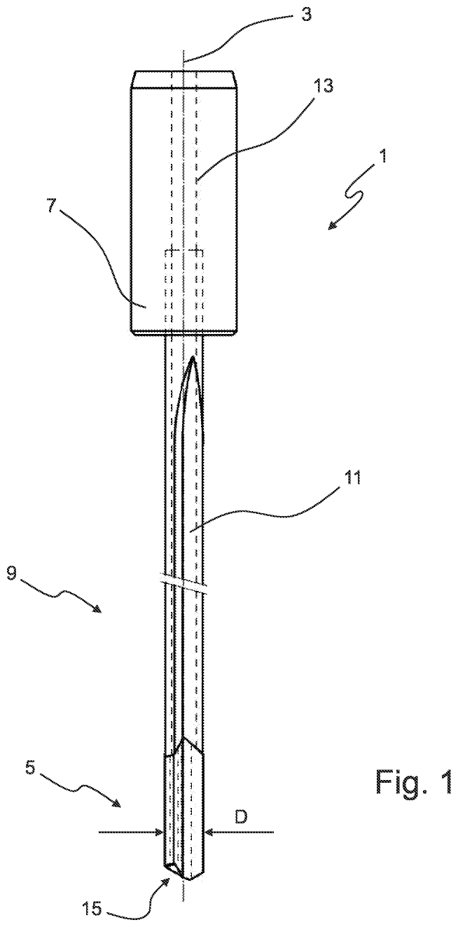

In all figures, the same reference signs are used for the same elements or components. FIG. 1 shows a single-lip drill provided in its entirety with the reference number 1. A central axis 3 is at the same time also the axis of rotation of the single-lip drill 1 or of the workpiece (not shown) when this is set in rotation during drilling.

A diameter of the single-lip drill 1 is denoted by D. The single-lip drill 1 is composed of three main components, specifically a drill head 5, a clamping sleeve 7 and a shank 9. Double-lip drills have the same structure and are therefore not shown separately. This structure is known to the person skilled in the art both from single-lip drills 1 and from double-lip drills (not shown) and is therefore not explained in detail.

In the shank 9 and the drill head 5 there is a longitudinal groove 11, which is also referred to as a bead. The longitudinal groove 11 has a cross section approximately in the form of a circular segment having an angle usually of approximately 90° to 130°. The longitudinal groove 11 extends from the tip of the drill up to in front of the clamping sleeve 7. Because of the longitudinal groove 11, the drill head 5 and shank 9 have a cross section approximately in the shape of a circular segment having an angle of usually 230° to 270° (a supplementary angle to the angle of the longitudinal groove 11).

A cooling channel 13 extends over the entire length of the single-lip drill 1. At one end of the clamping sleeve 7, coolant or a mixture of coolant and air is conveyed under pressure into the cooling channel 13. The coolant or the mixture of coolant and air flows out of the cooling channel 13 again at the opposite front end 15. The coolant has a plurality of functions. On the one hand, it cools and lubricates the cutting edge and the guide pads. In addition, it conveys the chips produced during drilling out of the borehole via the longitudinal groove 11.

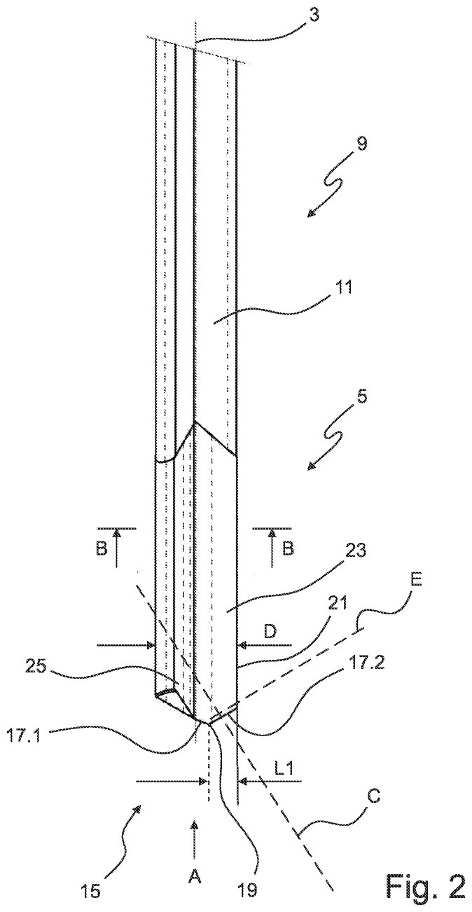

The front end 15 is shown somewhat enlarged in FIG. 2. Elements of the drill head 5 are explained in more detail on the basis of this figure.

In single-lip drills 1, a cutting edge 17 usually consists of an inner cutting edge 17.1 and an outer cutting edge 17.2. A cutting tip has the reference number 19. As is usual with single-lip drills, the cutting tip 19 is arranged at a radial distance from the central axis 3. The inner cutting edge 17.1 extends from the central axis 3 to the cutting tip 19. The outer cutting edge 17. 2 extends from the cutting tip 19 in the radial direction to the outer diameter D of the drill head 5 and ends at a secondary cutting edge 21.

A distance between the cutting tip 19 and the secondary cutting edge 21 is denoted by L₁ in FIG. 2. The (straight) longitudinal groove 11 is delimited by a planar rake face 23 and a planar wall 25. The rake face 23 and the wall 25 include an angle of approximately 130°. In the embodiment shown, the rake face 23 extends through the central axis 3. However, this does not have to be the case.

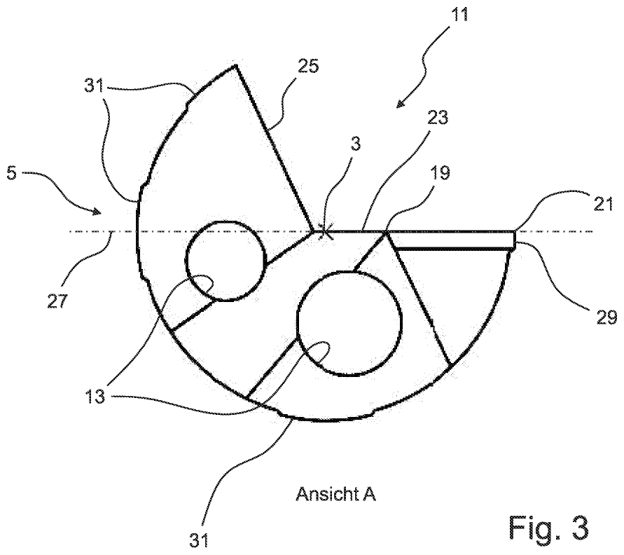

In FIG. 3, the central axis 3 is shown as “X. The straight (longitudinal) groove 11 is also clearly visible. It is defined by a rake face 23 and a wall 25. The rake face 23 and the wall 25 include an angle of approximately 130°. In the embodiment shown, the rake face 23 extends through the central axis 3. A rake face plane 27, indicated by a dot-dashed line, likewise extends through the central axis 3. The rake face plane 27 is a geometric definition which is not always visible on the single-lip drill. The rake face plane 27 is defined in that it extends parallel to the rake face 23 and through the central axis 3.

When the rake face 23 extends through the central axis 3, the rake face plane 27 and the rake face 23 coincide and the rake face plane 27 can be seen.

In FIG. 3, the inner cutting edge 17.1 can be seen as a line between the central axis 3 and the cutting tip 19. Correspondingly, the outer cutting edge 17.2 can be seen as a line between the cutting tip 19 and the secondary cutting edge 21. When viewed from the front, the inner cutting edge 17.1 and the outer cutting edge 17.2 coincide with the rake face 23. For the sake of clarity, reference signs 17.1 and 17.2 do not appear in FIG. 3.

A plurality of guide pads 29 and 31 are formed on the drill head 5, distributed over the circumference. The guide pad 29 and the rake face 23 form the secondary cutting edge 21 where they intersect. This guide pad is referred to below as a circular grinding chamfer 29. The circular grinding chamfer 29 and the guide pads 31 have the task of guiding the drill head 5 in the bore.

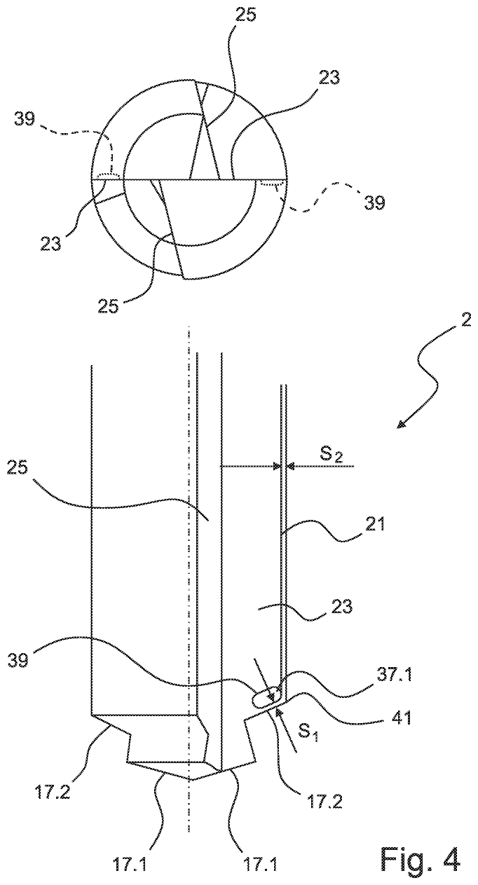

FIG. 4 shows an embodiment of a double-lip drill 2 according to the invention. When viewed from the side, both inner cutting edges 17.1 and both outer cutting edges 17.2 can be seen and a rake face 23 can be seen from above. In the two rake faces 23 (only one of which is visible) there are two depressions 37 according to the invention. The depressions 37 can be introduced into the rake face(s) 23 by means of grinding, eroding or ablation using a laser beam or another suitable method. Ultimately, the choice of method depends on the technological and geometric limiting conditions. For example, large grinding wheels cannot enter the rake face 23 where the rake face 23 is delimited by the wall 25. Therefore, small grinding wheels or grinding pins have to be used. This results in certain restrictions in the geometry of the depressions according to the invention. It is therefore sometimes necessary to introduce the depressions 37 by means of erosion or ablation using a laser beam. Using this method, almost all desired shapes of depressions 37 can be introduced almost anywhere into the rake face(s) 23.

As can be clearly seen from FIG. 4, there is a distance S₁ between an edge (without a reference number in FIG. 4) of the depression 37.1 and the outer cutting edge 17.2. This means that there is a narrow strip of the rake face 23 between the depression 37 and the outer cutting edge 17.2. As a result, in the case of such a tool, the rake angle is usually equal to zero degrees) (0°) and the wedge angle of the outer cutting edge 17.2 is correspondingly large. As a result, the cutting edge 17.2 is very robust and has a long service life. Despite the distance S₁, the depression 37 located behind the cutting edge 17.2 in the flow direction of the chips influences the chips sliding over it (not shown). The depression 37 deforms or influences the chip in such a way that the short chips desired during deep drilling are produced. By varying the number of depressions according to the invention, their geometry and/or their dimensions, the chips can be adapted in the desired manner in various ways.

In the shown embodiment, there is also a distance S₂ between the edge 39 of the depression 37.1 and the secondary cutting edge 21, such that the secondary cutting edge 21 is not weakened by the depression 37.1. The presence of the distances S₁ and S₂ has a particularly positive effect on the load capacity and the service life of the cutting corners 41, which, unlike when using conventional chip-forming devices, are not weakened by the depressions 37.

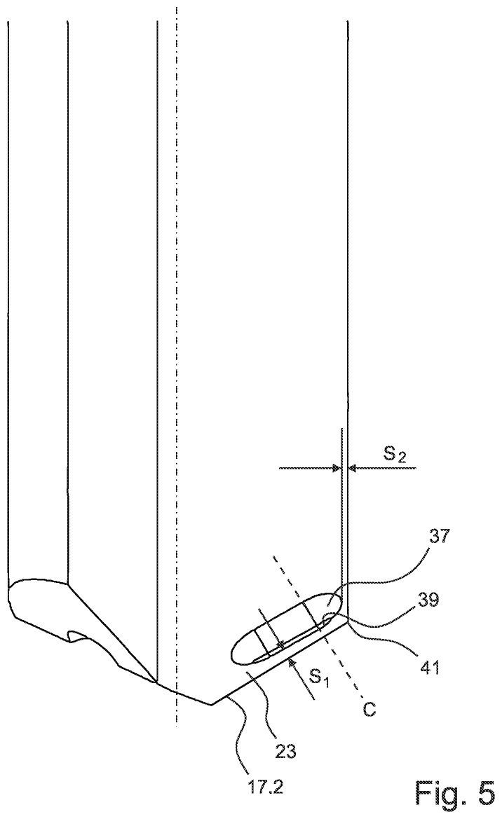

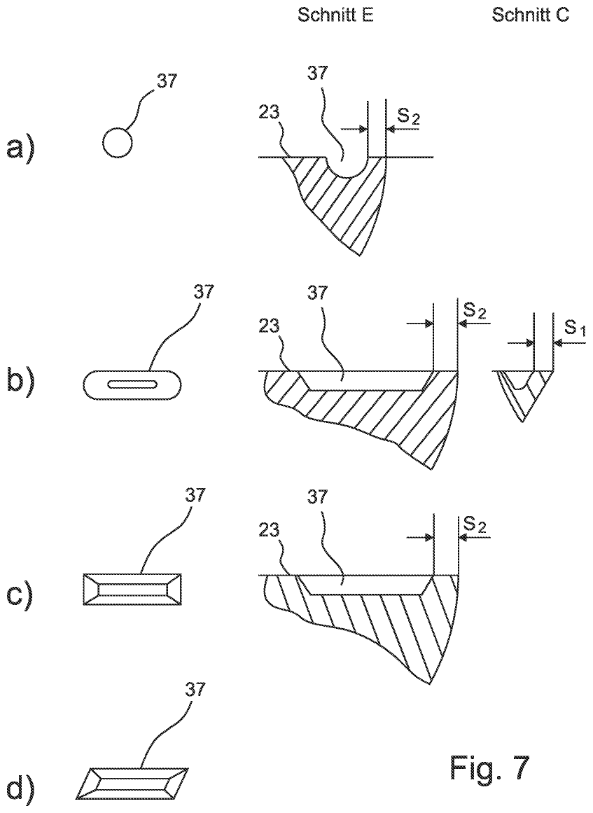

FIG. 5 shows an embodiment of a single-lip drill 1 according to the invention, in which a depression 37 according to the invention has been introduced into the rake face 23. The geometry of the depression 37 shown in FIG. 5 differs from that of the depression 37 according to FIG. 4. The specific shape of the depression 37 according to the invention is determined by the properties of the material to be machined and other parameters. FIG. 7 shows examples of differently designed depressions 37, which can be used both for single-lip drills and for double-lip drills.

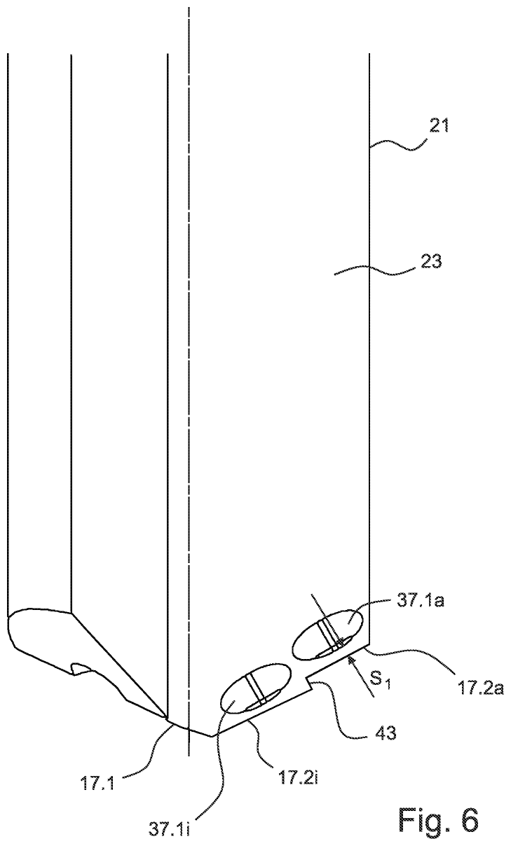

FIG. 6 shows an embodiment of a single-lip drill 1 according to the invention. In this single-lip drill 1, the outer cutting edge 17.2 is divided into two by a chip divider 43 (see reference signs 17.2i and 17.2a).

Accordingly, in this embodiment there are two depressions 37.1i and 37.1a in the rake face 23. It is also possible for a depression 37.1i, 37.1a (not shown) to be assigned to only one of the two cutting edges 17.2i or 17.2a.

FIG. 7 shows four different shapes of depressions 37 by way of example in different views (view from above, section along line E; section along line C; see FIG. 2). They can be used for single-lip drills, double-lip drills and other drilling tools. The optimal depression shape for the particular application can be selected through a combination of experience and drilling tests.

FIG. 7a) shows a spherical depression 37. It can be introduced into the rake face 23 with the aid of a grinding pin, by erosion or ablation using a laser beam. In the section along line E, the circular arc-shaped cross section or the dome-shaped shape of the depression 37 can be clearly seen.

FIG. 7b) shows an elongated depression 37 which has two parallel edges and the ends of which depression are delimited by a segment of a truncated cone. The section along line E and the section along line C show the geometry of this depression 37 in detail. It is also possible for the ends of this depression 37 to be delimited by a segment of a sphere (not shown).

The distances S₁ and S₂ appear in the sections along lines C and D.

The embodiment according to FIG. 7c shows a depression 37 having a rectangular outline. The section along line E can also be square or rectangular, such that the side walls of the depression 37 form a right angle with the rake face 23.

FIG. 7d) shows a depression 37 having the base of a parallelogram.

It is obvious that the depressions according to the invention can have a large number of different geometries. It is also obvious that the embodiments shown are only of a descriptive, but not limiting, nature.

In the interests of economical production, the aim is, of course, to remove as little material from the rake face as possible. One possibility of minimizing the volume to be removed for the depression 37 is to introduce two small depressions 37, as is shown by way of example in FIG. 6. It is not necessary for the assigned cutting edge to have a chip divider 43. For example, it is also possible to arrange two or more depressions behind the outer cutting edge 17.2 (not shown).

Such a depression 37 can have various shapes. Ultimately, these depressions usually have a base that is more circular or square, and there is a web between the adjacent depressions 37. The rake face 23 is present in the region of the web. The effect according to the invention also occurs in this embodiment, specifically that of influencing the chips that are discharged over the rake face 23 in such a way that the desired short chips are produced.

This includes the option of only one depression being arranged behind the cutting edge 17.2.

Two or three depressions can also be arranged behind the cutting edge 17.2. The number and size of the depressions are always selected according to the requirements of the application.

In the following, some terms are briefly explained and defined.

The overall shape of all cutting and non-rake faces on the end face of the drill head is referred to as the nose grind. This also includes surfaces that do not directly adjoin the cutting edges, for example surfaces for directing the coolant flow or additional flanks to allow the drill to cut cleanly. The nose grind determines the shaping of the chips to a large extent and is matched to the material to be machined. The aims of the matching are, among other things, shaping chips that are as favorable as possible, a high machining speed, the longest possible service life of the drill, and compliance with the required quality characteristics of the bore such as diameter, surface or straightness (centerline).

To increase the service life, the drill head can be provided with a coating as wear protection, mostly from the group consisting of metal nitrides or metal oxides; the coating can also be provided in a plurality of alternating layers. The thickness is usually approx. 0.0005 to 0.010 mm. The coating is carried out by means of chemical or physical vacuum coating processes. The coating can be provided on the circumference of the drill head, on the flanks or on the rake faces, and in some cases the entire drill head can also be coated.

Single-lip drills and double-lip drills are variants of deep hole drills. Deep hole drills are understood to mean tools that work according to various known deep hole drilling systems (for example BTA, ejector drilling, single-lip or double-lip deep hole drilling).

Single-lip drills and double-lip drills are long and slender and have a central axis. The rake face thereof is planar; hence they are also referred to as “straight grooved” tools. They are used to create bores that have a large length to diameter ratio. They are mainly used in industrial metalworking, such as in the production of engine components, in particular in the production of common rails or gear shafts.

Single-lip drills are usually used in a diameter range of approx. 0.5 to 50 mm. Bores having a length of up to about 6,000 mm are possible.

The length to diameter ratio (L/D) of the bore is usually in a range from approx. 10 to over 100; however, it can also be approx. 5 and up to about 250.

Single-lip drills are characterized by the fact that a high-quality bore can be produced in one stroke. They can be used in machine tools such as lathes, machining centers or special deep drilling machines.

The machining process takes place by means of a relative movement of the drill to the workpiece in the direction of rotation about a common central axis, and a relative movement of the drill towards the workpiece in the direction of the common central axis (feed movement). The rotational movement can be caused by means of the drill and/or the workpiece. The same applies to the feed movement.

The flank is the surface at the tip of the drill head that is opposite the machined workpiece surface.

Guide pads are arranged on the circumference of the drill head to support the cutting forces in the drilled bore which arise during cutting. Guide pads are cylinder segments having the diameter of the drill head; they abut the wall of the bore during the drilling process. Radially recessed segments having a smaller diameter are arranged on the drill head, between the guide pads in the circumferential direction, such that a gap is formed between the bore wall and the drill head. The gap is used to collect coolant for cooling and lubricating the guide pads.

There are different arrangements of guide pads; the design depends on the material to be machined. The first guide pad, which adjoins the rake face counter to the direction of rotation of the drill, is referred to as the circular grinding chamfer.

Coolant or a mixture of coolant and air (minimum quantity lubrication) is conveyed through the cooling channel to lubricate and cool the drill head and the guide pads as well as to flush out the chips. Coolant is supplied under pressure to the rear end, passes through the cooling channel and exits at the drill head. The pressure depends on the diameter and length of the drill.

By adapting the pressure of the coolant, single-lip drills and double-lip drills can drill very small and very deep bores in one go.

During the drilling process, the deviation [mm] of the actual bore path from the theoretical central axis of the drill is considered to be the mismatch of axes. The mismatch of axes is an aspect of the bore quality. The aim is to achieve the smallest possible mismatch of axes. In the ideal case, there is no mismatch of axes at all.

The mismatch of axes depends, among other things, on whether the rotational movement is carried out by the drill or the workpiece or both. Experience shows that the smallest mismatch-of-axes values are achieved when the rotational movement is carried out by the workpiece or by the workpiece and the drill.

A depression is a recess machined into the rake face. In contrast to a chip-forming device, the depression does not directly adjoin the cutting edge. The same applies in many cases to the secondary cutting edge, as well. In other words: A narrow strip of the rake face remains between the (main) cutting edge and the depression.

A single-lip drill or double-lip drill which has become dull can be used again by means of regrinding. Regrinding means readjusting/grinding the worn part of the drill head mostly on the end face until all worn regions (in particular of the rake face and flank) have been removed and a new, sharp cutting edge has been formed. The nose grind then reverts to its original shape.

The line of contact (edge) between the rake face and the circular grinding chamfer is referred to as the secondary cutting edge. The point of intersection between the outer cutting edge and the secondary cutting edge is referred to as the cutting corner.

The drill head has at least one cutting edge; there can also be a plurality of cutting edges. The cutting edge is the region that is involved in the machining. The cutting edge is the line of intersection of the rake face and the flank. The cutting edge is usually divided into a plurality of straight partial cutting edges.

The rake face is the region at which the chip is discharged; it can also consist of a plurality of partial surfaces.

A chip-forming device is a recess machined into the rake face, extending parallel to the cutting edge and directly adjoining the cutting edge. In other words: There is no rake face between the cutting edge and the chip-forming device.

A chip divider constitutes a “break” in the outer cutting edge, which reduces the width of the chips.

What is claimed is:

1. Deep hole drill comprising a drill head, the drill head having an axis of rotation, a drilling diameter (D) and one or two cutting edges, a rake face being associated with each cutting edge, characterised in that at least one depression is incorporated in the rake face, wherein a narrow strip of the rake face (23) remainis between an edge of the depression (37) and the main cutting edge (17) and between the edge of the depression (37() and the secondary cutting edge (21).

2. Deep hole drill according to claim 1, characterized in that the deep hole drill is a single-lip drill having a rake face.

3. Deep hole drill according to claim 1, characterized in that the deep hole drill is a double-lip drill having two rake faces.

4. Deep hole drill according to claim 1, characterized in that a cross section of the at least one depression in a sectional plane (C) which extends orthogonally to the cutting edge has the shape of an isosceles or non-isosceles triangle.

5. Deep hole drill according to claim 1, characterized in that a cross section of the at least one depression in a sectional plane (C) which extends orthogonally to the cutting edge is at least partially curved.

6. Deep hole drill according to claim 1, characterized in that a cross section of the at least one depression in a sectional plane (C) which extends orthogonally to the cutting edge is composed of straight and curved portions.

7. Deep hole drill according to claim 1, characterized in that the at least one depression in a sectional plane (C) which extends orthogonally to the cutting edge has the shape of a circular arc.

8. Deep hole drill according to claim 1, characterized in that a cross section of the at least one depression in a sectional plane (E) which extends parallel to the cutting edge has the shape of a rectangle or a trapezoid.

9. Deep hole drill according to claim 1, characterized in that a cross section of the at least one depression in a sectional plane (E) which extends parallel to the cutting edge is at least partially curved.

10. Deep hole drill according to claim 1, characterized in that a cross section of the at least one depression in a sectional plane (E) which extends parallel to the cutting edge is composed of straight and curved portions.

11. Deep hole drill according to, characterized in that the at least one depression in a sectional plane (E) which extends parallel to the cutting edge has the shape of a circular arc.

12. Deep hole drill according to claim 1, characterized in that a distance (S₁) between an edge of the depression and the cutting edge is at least 0.05 mm.

13. Deep hole drill according to claim 1, characterized in that a distance (S₂) between the edge of the depression and the secondary cutting edge (21) is at least 0.05 mm.

14. Deep hole drill according to claim 1, characterized in that two or more depressions are arranged along the cutting edge.

15. Deep hole drill according to claim 1, characterized in that it comprises a chip divider which divides the cutting edge into an inner portion and an outer portion.

16. Deep hole drill according to claim 15, characterized in that a depression is assigned to the inner portion of the cutting edge.

17. Deep hole drill according to claim 15, characterized in that a depression is assigned to the outer portion of the cutting edge.

18. Deep hole drill according to claim 1, characterized in that the drill head is completely or partially provided with a hard material coating.
